(19) United States
(12) Patent Application Publication
(10) Pub. No.: US 2026/0220753 A1
(43) Pub. Date: Jul. 30, 2026

(54) SYSTEM AND METHOD FOR DETECTING BRIGHT SPOTS IN PHOTO-VOLTAIC SOLAR PANEL

(71) Applicant: JIO PLATFORMS LIMITED, Ahmedabad (IN)

(72) Inventors: Kedar KULKARNI, Karnataka (IN); Anand THIRWANI, Delhi (IN); Rahul S NAIR, Kerala (IN)

(73) Assignee: JIO PLATFORMS LIMITED, Ahmedabad (IN)

(21) Appl. No.: 19/148,630

(22) PCT Filed: May 14, 2024
(86) PCT No.: PCT/IB2024/054670

§ 371 Date: Jul. 16, 2025

(30) Foreign Application Priority Data
May 31, 2023 (IN) 202321037692

(51) Int. Cl. G06T 7/00; G06T 7/60; G06T 7/73; G06V 10/22; G06V 10/26; G06V 10/30; G06V 10/56; G06V 10/764; G06V 10/774; G06V 10/82; G06V 20/60

(52) U.S. Cl. CPC G06T 7/0002; G06T 7/60; G06T 7/73; G06V 10/26; G06V 10/30; G06V 10/56; G06V 10/764; G06V 10/774; G06V 10/82; G06V 20/60; G06T 2207/20021; G06T 2207/20076; G06T 2207/20081; G06T 2207/20084; G06T 2207/30242; G06V 10/225

(57) ABSTRACT

The present disclosure relates to a system and a method for detecting bright spots in a Photo-Voltaic (PV) solar panel. The system receives an electroluminescence (EL) image of a PV solar panel, extract one or more optimal patches from the received EL image of the PV solar panel, extract one or more features from the extracted one or more optimal patches, generate 5 one or more synthetic bright spots to train a classification model based on the extracted one or more features, and detect bright spots in the PV solar panel via the classification model.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to Photo-Voltaic (PV) solar panel detection. In particular, the present disclosure relates to a system and a method for detecting bright spots in the PV solar panel.

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In general, a solar panel or a Photo-Voltaic (PV) panel is an electronic device that converts incident solar energy (sunlight) directly into electricity through photovoltaic effect. Solar energy is increasingly becoming an important source of energy since it reduces dependency on greenhouse-gas emitting non-renewable fossil-fuels, thus mitigating climate change. In recent years, the production and adoption of the PV solar panels to harness solar energy has grown rapidly due to its increasing cost-effectiveness, scalability, and sustainability. To ensure that the PV solar panels produce power safely and efficiently, it is crucial to rapidly detect defects during the PV solar panel manufacturing process itself. Defects such as cracks, voids, and impurities on the PV solar panel may significantly impact the performance of the PV solar panel, and reduce lifespan and power output of the PV solar panel. ‘Bright spot’ defect, which occurs when a localized area on the PV solar panel surface, has low resistance and produces excessive energy, leads to short circuits, heating, and potentially fires. Therefore, it is important to implement effective quality control to detect bright spots automatically and accurately during the manufacturing process.

Conventional methods and systems implement infrared imaging of a group of solar panels to identify defects comprising of temperature hotspots based on a comparison with a threshold value. Further, the conventional methods and systems identify individual PV solar panels from a group through edge detection, but do not detect the bright spots found in Electroluminescence (EL) images of the PV solar panels during their production or manufacturing process, thereby, leading to short circuits, heating, and potentially fires in the PV solar panel.

There is, therefore, a need in the art to provide a system and a method for effectively detecting bright spot defects in the PV solar panels to overcome the deficiencies of the prior arts.

### OBJECTS OF THE PRESENT DISCLOSURE

Some of the objects of the present disclosure, which at least one embodiment herein satisfies are as listed herein below.

It is an object of the present disclosure to extract optimal patches discriminatively from an input Electroluminescence (EL) image of a Photo-Voltaic (PV) solar panel to train a detection system.

It is an object of the present disclosure to determine features that enable the detection system to efficiently discriminate bright spots from regular areas on a PV solar panel surface.

It is an object of the present disclosure to create synthetic bright spots to generate more realistic labelled data to train classification models more efficiently.

It is an object of the present disclosure to extract patches with bright spots while removing noise in data to avoid any false positives.

It is an object of the present disclosure to capture inherent characteristics of bright spots in order to personalise the features to enhance discriminative capacity of the detection system.

It is an object of the present disclosure to extract and exploit unique properties of real bright spot EL images to simulate the bright spots.

It is an object of the present disclosure to efficiently detect the bright spots in the PV solar panel during manufacturing process via the classification models, thereby avoiding short circuits, heating, and potentially fires in the PV solar panel.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for detecting bright spots in a Photo-Voltaic (PV) solar panel. The system includes one or more processors, and a memory operatively coupled to the one or more processors, where the memory includes processor-executable instructions, which on execution, cause the one or more processors to receive an electroluminescence (EL) image of a PV solar panel, extract one or more optimal patches from the received EL image of the PV solar panel, extract one or more features from the extracted one or more optimal patches, generate one or more synthetic bright spots to train a classification model based on the extracted one or more features, and detect bright spots in the PV solar panel via the classification model.

In an embodiment, the received EL image of the PV solar panel may include one or more optimal patches with the bright spots and one or more patches with no bright spots marked using one or more coloured bounding boxes.

In an embodiment, the processor may extract the one or more optimal patches from the received EL image of the PV solar panel by being configured to detect one or more coloured pixels from the received EL image of the PV solar panel, identify one or more coloured bounding boxes based on the one or more coloured pixels, convert pixel intensity of the one or more coloured bounding boxes to 0 to remove noise from the received EL image of the PV solar panel, and extract the one or more optimal patches from the received EL image of the PV solar panel based on the pixel intensity.

In an embodiment, the memory includes processor-executable instructions, which on execution, may cause the one or more processors to extract one or more PV cells from the PV solar panel.

In an embodiment, the processor may extract the one or more PV cells from the PV solar panel by being configured to identify a number of modules in the PV solar panel, split the EL image of the PV solar panel into one or more PV module EL images based on the number of modules in the PV solar panel, identify a number of cells in at least one PV module EL image of the one or more PV module EL images, split the at least one PV module EL image into one or more PV cells EL images, and extract the one or more PV cells based on the one or more PV cells EL images.

In an embodiment, the memory includes processor-executable instructions, which on execution, may cause the one or more processors to split the one or more PV cells EL images into equal sized patches and identify exact location of at least one bright spot in the PV solar panel.

In an embodiment, the memory includes processor-executable instructions, which on execution, may cause the one or more processors to identify a size of the one or more optimal patches, where the one or more optimal patches may be one or more patches with the bright spots.

In an embodiment, the processor may identify the size of the one or more optimal patches by being configured to split one or more PV cell EL images into at least one grid which maximizes difference between the one or more patches with the bright spots and one or more patches with no bright spots, determine an average distance between the one or more patches with the bright spots and the one or more patches with no bright spots, determine a mean value of the average distance between the one or more patches with the bright spots and the one or more patches with no bright spots over all the one or more PV cell EL images, and identify the size of the one or more patches with the bright spots based on the mean value.

In an embodiment, the processor may extract the one or more features from the extracted one or more optimal patches by being configured to determine whether pixel intensity of each pixel of one or more patches is greater than a pre-configured value using an Inverse Cumulative Density Function (ICDF), detect one or more patches comprising a bright spot as the one or more optimal patches in response to a determination that the pixel intensity of each pixel of the one or more patches is greater than the pre-configured value, extract the one or more optimal patches based on the detection, and extract the one or more features from the extracted one or more optimal patches based on the pixel intensity of each pixel of the extracted patches and a gradient of the ICDF.

In an embodiment, the one or more features may include at least one of a value of maximum pixel intensity, a flag representing high pixel intensity, a slope of ICDF between any intervals of pixel intensity percentiles, and a ratio of ICDF between any intervals of pixel intensity percentiles.

In an embodiment, the processor may generate the one or more synthetic bright spots by being configured to extract at least one bright spot region for each patch comprising the bright spots, determine a spatial probability distribution of the bright spots, determine a probability distribution of the at least one bright spot region by detecting a number of elements in the at least one bright spot region, generate at least one synthetic bright spot region based on the spatial probability distribution of the bright spots and the probability distribution of the at least one bright spot region, and generate the one or more synthetic bright spots by capturing and pre-processing the at least one synthetic bright spot region.

In an embodiment, the memory includes processor-executable instructions, which on execution, may cause the one or more processors to receive the extracted one or more optimal patches as input, extract image embeddings from the received EL image of the PV solar panel via a pre-trained Convolutional Neural Network (CNN) model, augment the extracted one or more features with the extracted image embeddings, and train an anomaly detection model to detect the bright spots.

In an embodiment, the anomaly detection model may be trained on one or more patches with no bright spots.

In an embodiment, the processor may detect the bright spots in the PV solar panel by being configured to generate realistic bright spot images for the one or more synthetic bright spots by training a Generative Adversarial Network (GAN) with the one or more synthetic bright spots, blend the realistic bright spot images on top of one or more patches with no bright spot to emulate the bright spots, extract one or more features from one or more patches with the bright spots and one or more features from one or more patches with no bright spots in response to blending the realistic bright spot images, and train the classification model based on the extracted one or more features of the one or more patches with the bright spots and the extracted one or more features of the one or more patches with no bright spots.

In another aspect, the present disclosure relates to a method for detecting bright spots in a PV solar panel. The method includes receiving, by a processor associated with a system, an EL image of a PV solar panel, extracting, by the processor, one or more optimal patches from the received EL image of the PV solar panel, extracting, by the processor, one or more features from the extracted one or more optimal patches, generating, by the processor, one or more synthetic bright spots to train a classification model based on the extracted one or more features, and detecting, by the processor, bright spots in the PV solar panel via the classification model.

In an embodiment, the received EL image of the PV solar panel may include one or more optimal patches with the bright spots and one or more patches with no bright spots marked using one or more coloured bounding boxes.

In an embodiment, extracting, by the processor, the one or more optimal patches from the received EL image of the PV solar panel may include detecting, by the processor, one or more coloured pixels from the received EL image of the PV solar panel, identifying, by the processor, one or more coloured bounding boxes based on the one or more coloured pixels, converting, by the processor, pixel intensity of the one or more coloured bounding boxes to 0 to remove noise from the received EL image of the PV solar panel, and extracting, by the processor, the one or more optimal patches from the received EL image of the PV solar panel.

In an embodiment, the method may include extracting, by the processor, one or more PV cells from the PV solar panel.

In an embodiment, extracting, by the processor, the one or more PV cells from the PV solar panel may include identifying, by the processor, a number of modules in the PV solar panel, splitting, by the processor, the EL image of the PV solar panel into one or more PV module EL images based on the number of modules in the PV solar panel, identifying, by the processor, a number of cells in at least one PV module EL image of the one or more PV module EL images, splitting, by the processor, the at least one PV module EL image into one or more PV cells EL images, and extracting, by the processor, the one or more PV cells based on the one or more PV cells EL images.

In an embodiment, the method may include splitting, by the processor, the one or more PV cells EL images into equal sized patches, and identifying, by the processor, exact location of at least one bright spot in the PV solar panel.

In an embodiment, the method may include identifying, by the processor, a size of the one or more optimal patches, where the one or more optimal patches may be one or more patches including the bright spots.

In an embodiment, identifying, by the processor, the size of the one or more optimal patches may include splitting, by the processor, one or more PV cell EL images into at least one grid which maximizes difference between the one or more patches with the bright spots and one or more patches with no bright spots, determining, by the processor, an average distance between the one or more patches with the bright spots and the one or more patches with no bright spots, determining, by the processor, a mean value of the average distance between the one or more patches with the bright spots and the one or more patches with no bright spots over all the PV cell EL images, and identifying, by the processor, the size of the one or more patches with the bright spots based on the mean value.

In an embodiment, extracting, by the processor, the one or more features from the extracted one or more optimal patches may include determining, by the processor, whether pixel intensity of each pixel of one or more patches is greater than a pre-configured value via an ICDF, detecting, by the processor, one or more patches comprising a bright spot as the one or more optimal patches in response to a determination that the pixel intensity of each pixel of the one or more patches is greater than the pre-configured value, extracting, by the processor, the one or more optimal patches based on the detection, and extracting, by the processor, the one or more features from the extracted one or more optimal patches based on the pixel intensity of each pixel of the extracted patches and a gradient of the ICDF.

In an embodiment, the one or more features may include at least one of a value of maximum pixel intensity, a flag representing high pixel intensity, a slope of ICDF between any intervals of pixel intensity percentiles, and a ratio of ICDF between any intervals of pixel intensity percentiles.

In an embodiment, generating, by the processor, the one or more synthetic bright spots may include extracting, by the processor, at least one bright spot region for each patch including the bright spots, determining, by the processor, a spatial probability distribution of the bright spots, determining, by the processor, a probability distribution of the at least one bright spot region by detecting a number of elements in the at least one bright spot region, generating, by the processor, at least one synthetic bright spot region based on the spatial probability distribution of the bright spots and the probability distribution of the at least one bright spot region, and generating, by the processor, the one or more synthetic bright spots by pre-processing the at least one synthetic bright spot region.

In an embodiment, the method may include receiving, by the processor, the extracted one or more optimal patches as an input, extracting, by the processor, image embeddings from the received EL image of the PV solar panel via a pre-trained CNN model, augmenting, by the processor, the extracted one or more features with the extracted image embeddings, and training, by the processor, an anomaly detection model to detect the bright spots.

In an embodiment, the anomaly detection model may be trained on one or more patches with no bright spots.

In an embodiment, detecting, by the processor, the bright spots in the PV solar panel may include generating, by the processor, realistic bright spot images for the one or more synthetic bright spots by training a GAN the with one or more synthetic bright spots, blending, by the processor, the realistic bright spot images on top of one or more patches with no bright spots to emulate the bright spots, extracting, by the processor, one or more features from one or more patches with the bright spots and one or more features from one or more patches with no bright spots in response to blending the realistic bright spot images, and training, by the processor, the classification model based on the extracted one or more features of the one or more patches with the bright spots and the extracted one or more features of the one or more patches with no bright spots.

In another aspect, the present disclosure relates to a user equipment. The user equipment includes one or more processors, and a memory operatively coupled to the one or more processors, wherein the memory includes processor-executable instructions, which on execution, cause the one or more processors to capture an EL image of a PV solar panel, and send the EL image of the PV solar panel to a system. The one or more processors are communicatively coupled with the system, and the system is configured to receive the EL image of the PV solar panel, extract one or more optimal patches from the received EL image of the PV solar panel, extract one or more features from the extracted one or more optimal patches, generate one or more synthetic bright spots to train a classification model based on the extracted one or more features, and detect bright spots in the PV solar panel via the classification model.

In an aspect, the present disclosure relates to a non-transitory computer-readable medium including processor-executable instructions that cause a processor to receive an EL image of a PV solar panel, extract one or more optimal patches from the received EL image of the PV solar panel, extract one or more features from the extracted one or more optimal patches, generate one or more synthetic bright spots to train a classification model based on the extracted one or more features, and detect bright spots in the PV solar panel via the classification model.

### BRIEF DESCRIPTION OF THE DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

The diagrams are for illustration only, which thus is not a limitation of the present disclosure, and wherein:

FIG. 1 illustrates an exemplary system architecture (100) of a bright spot detection module in which or with which embodiments of the present disclosure may be implemented.

FIG. 2 illustrates an exemplary block diagram (200) of a bright spot detection system, in accordance with an embodiment of the present disclosure.

FIG. 3 illustrates an exemplary flow diagram (300) for capturing an Electroluminescence (EL) image of a Photo-Voltaic (PV) cell panel, in accordance with an embodiment of the present disclosure.

FIG. 4 illustrates an exemplary representation (400) for extracting PV cells from the EL image of the PV solar panel, in accordance with an embodiment of the present disclosure.

FIG. 5 illustrate an exemplary flow diagram (500) for determining optimal patch size for patch extraction, in accordance with an embodiment of the present disclosure.

FIGS. 6A and 6B illustrate exemplary representations (600A, 600B) for splitting the PV cell into equal sized optimal patches, in accordance with embodiments of the present disclosure.

FIG. 7 illustrates an exemplary view (700) representing a probability distribution of a patch with bright spot and a probability distribution of a patch with no bright spot, in accordance with an embodiment of the present disclosure.

FIG. 8 illustrates an exemplary graphical view (800) representing a comparison between the patch with bright spot and the patch with no bright spot, in accordance with an embodiment of the present disclosure.

FIG. 9 illustrates an exemplary flow diagram (900) for training an anomaly detection module, in accordance with an embodiment of the present disclosure.

FIGS. 10A and 10B illustrate exemplary flow diagrams (1000A, 1000B) for generating synthetic bright spots, in accordance with embodiments of the present disclosure.

FIG. 11 illustrates exemplary views (1100) representing spatial probability distribution of the bright spots, in accordance with an embodiment of the present disclosure.

FIG. 12 illustrates exemplary views (1200) representing probability distribution of the bright spot region, in accordance with an embodiment of the present disclosure.

FIG. 13 illustrates an exemplary flow diagram (1300) for generating synthetic bright spot image, in accordance with an embodiment of the present disclosure.

FIG. 14 illustrates an exemplary flow diagram (1400) representing pre-processing of the synthetic bright spot image, in accordance with an embodiment of the present disclosure.

FIG. 15 illustrates an exemplary flow diagram (1500) for training a classification model, in accordance with an embodiment of the present disclosure.

FIG. 16 illustrates an exemplary computer system (1600) in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In recent times, the production and adoption of Photo-Voltaic (PV) solar panels to harness solar energy has grown rapidly due to its increasing cost-effectiveness, scalability, and sustainability. To ensure that the PV solar panels produce power safely and efficiently, defects in the PV solar panels have to be detected rapidly during the PV panel manufacturing process itself. Defects such as cracks, voids, and impurities on the PV solar panel may significantly impact performance, and reduce lifespan and power output of the of the PV solar panels. Further, a ‘bright spot’ defect, which occurs when a localized area on a PV solar panel surface has low resistance and produces excessive energy, leads to short circuits, heating, and potentially fires. Therefore, it is important to implement effective quality control to detect the bright spots automatically and accurately during the manufacturing process. However, these bright spots are very rare, thus making it very challenging to build a reliable model to detect the bright spots.

The present disclosure discloses a robust three-pronged approach to enhance accuracy and reliability of a bright spot detection system, with the following components: optimal patch extraction, feature extraction, and synthetic bright spot generation. Optimal patch extraction extracts discriminatively optimal patches from an input Electroluminescence (EL) image of a PV solar panel to train the bright spot detection system. Feature extraction computes features that enable the bright spot detection system to efficiently discriminate bright spots from regular areas on the PV solar panel surface. Synthetic bright spot generation creates synthetic bright spots to generate more realistic labelled data to train classification models more efficiently.

Therefore, embodiments of the present disclosure relate to effectively detecting the bright spot defects in the PV solar panels by overcoming an extreme imbalance in data between the PV solar panels that have bright spots versus the PV solar panels that do not have the bright spots.

In an embodiment, the present disclosure detects the bright spots occurring in the PV solar panel during the manufacturing process of the PV solar panel itself. Thereby, preventing short-circuits and localized heating of the PV solar panels, and reducing the risk of fire caused due to the bright spots in the PV solar panel. The bright spot defect detection system automatically detects the bright spots occurring in the PV solar panel such that time and effort required to identify defective PV solar panels are reduced.

Certain terms and phrases have been used throughout the disclosure and will have the following meanings in the context of the ongoing disclosure.

The term “PV solar panel” may refer to a solar panel or a Photo-Voltaic (PV) panel, which is an electronic device that converts incident solar energy (sunlight) directly into electricity through the photovoltaic effect.

The term “bright spot” may refer to a defect that rarely occurs in the PV solar panel and causes short circuits and heating of the PV solar panel.

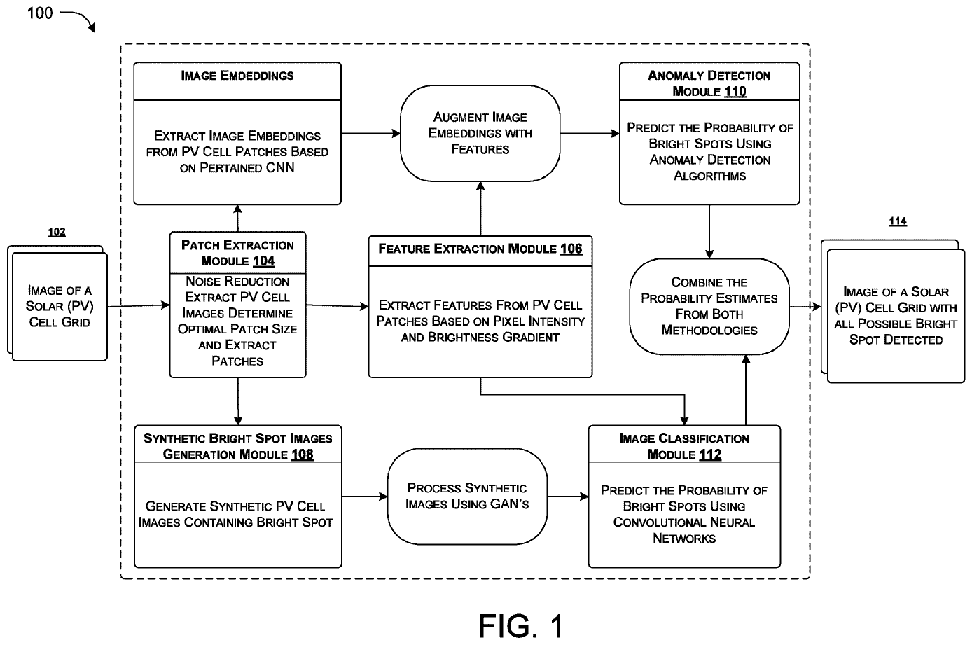

Various embodiments of the present disclosure will be explained in detail with reference to FIGS. 1-16.

FIG. 1 illustrates an exemplary system architecture (100) of a bright spot detection module in which or with which embodiments of the present disclosure may be implemented.

Referring to FIG. 1, the system architecture (100) may include one or more components which include, but not limited to, a patch extraction module (104), a feature extraction module (106), a synthetic bright spot images generation module (108), an anomaly detection module (110), and an image classification module (112).

In an embodiment, the patch extraction module (104) may receive EL images (102) of a PV solar panel as an input and return annotated EL images (102) with a bounding box on locations where the bright spots are detected. The presence of the bounding boxes may act as noise during bright spot detection. The patch extraction module (104) may remove noise from the EL images (102).

In an embodiment, the PV solar panel may be composed of multiple PV cells connected in series or parallel to add up the voltage and current to match the output power requirements. The patch extraction module (104) may extract the PV cell images by splitting the EL images (102) into multiple PV cell images. Each PV cell may include one or more patches with bright spots and one or more patches without bright spots. The patch extraction module (104) may determine the size of each patch with bright spots and extract the patch with bright spot based on the size of the patch.

In an embodiment, the patch extraction module (104) may also extract image embeddings from the PV cell patches based on a Convolutional Neural Network (CNN).

In an embodiment, the PV cell patches may include a number of pixels. The feature extraction module (106) may determine pixel intensity and brightness gradient of each pixel of the PV cell patches. Further, the feature extraction module (106) may extract the features from the PV cell patches based on the pixel intensity and the brightness gradient of each pixel of the PV cell patches.

In an embodiment, the synthetic bright spot image generation module (108) may receive the extracted PV cell images from the patch extraction module (104), and generate synthetic bright spot images based on the received PV cell images.

In an embodiment, the anomaly detection module (110) may receive the extracted image embeddings of the PV cell patches from the patch extraction module (104), and the extracted features of the PV cell patches from the feature extraction module (106). Further, the anomaly detection module (110) may augment the extracted image embeddings of the PV cell patches with the extracted features of the PV cell patches to train an anomaly detection model. The anomaly detection module (110) may predict probability of bright spots based on the augmented data via the anomaly detection model.

In an embodiment, the image classification module (112) may receive the synthetic PV cell images containing the bright spot from the synthetic bright spot image generation module (108), and pre-process the synthetic PV cell images containing the bright spot via a Generative Adversarial Network (GAN). The image classification module (112) may also receive the features of PV cell patches extracted from the feature extraction module (106). The image classification module (112) may predict the probability of bright spots based on the pre-processed images and the features of PV cell patches via the CNN.

In an embodiment, the system (100) may combine the probability of the bright spots predicted by the anomaly detection module (110) and the probability of the bright spots predicted by the image classification module (112) to output an image (114) of a PV cell grid with the bright spots.

Although FIG. 1 shows exemplary components of the system architecture (100), in other embodiments, the system architecture (100) may include fewer components, different components, differently arranged components, or additional functional components than depicted in FIG. 1. Additionally, or alternatively, one or more components of the system architecture (100) may perform functions described as being performed by one or more other components of the system architecture (100).

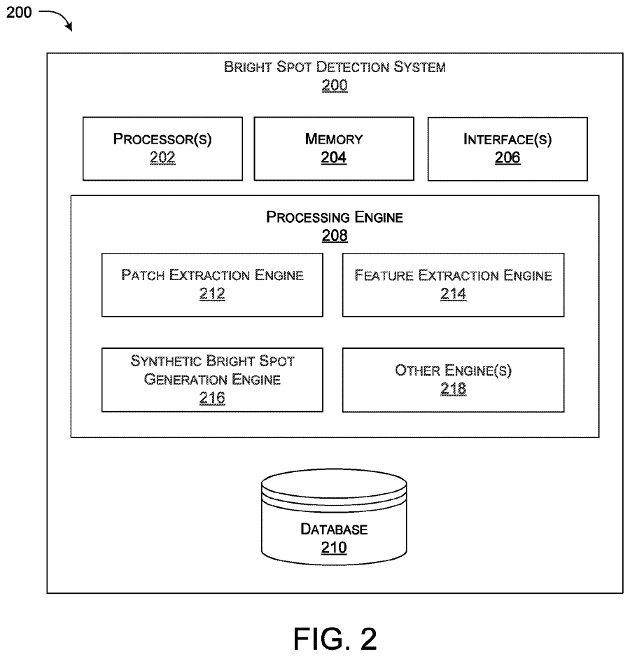

FIG. 2 illustrates an exemplary block diagram of a bright spot detection system (200), in accordance with an embodiment of the present disclosure. It may be appreciated that the system (200) may be similar to the system (100) of FIG. 1 in its functionality.

In an embodiment, and as shown in FIG. 2, the system (200) may include one or more processors (202). The one or more processors (202) may be implemented as one or more microprocessors, microcomputers, microcontrollers, digital signal processors, central processing units, logic circuitries, and/or any devices that manipulate data based on operational instructions. Among other capabilities, the one or more processor(s) (202) may be configured to fetch and execute computer-readable instructions stored in a memory (204) of the system (200). The memory (204) may store one or more computer-readable instructions or routines, which may be fetched and executed to create or share the data units over a network service. The memory (204) may comprise any non-transitory storage device including, for example, volatile memory such as Random-Access Memory (RAM), or non-volatile memory such as Erasable Programmable Read-Only Memory (EPROM), flash memory, and the like.

In an embodiment, the system (200) may also comprise an interface(s) (206). The interface(s) (206) may comprise a variety of interfaces, for example, a variety of interfaces, for example, interfaces for data input and output devices, referred to as I/O devices, storage devices, and the like. The interface(s) (206) may facilitate communication of the system (200) with various devices coupled to it. The interface(s) (206) may also provide a communication pathway for one or more components of the system (200). Examples of such components include, but are not limited to, processing engine(s) (208) and a database (210).

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the one or more processors (202) may comprise a processing resource (for example, one or more processors), to execute such instructions. In the present examples, the machine-readable storage medium may store instructions that, when executed by the processing resource, implement the processing engine(s) (208). In such examples, the system (200) may comprise the machine-readable storage medium storing the instructions and the processing resource to execute the instructions, or the machine-readable storage medium may be separate but accessible to the system (200) and the processing resource. In other examples, the processing engine(s) (208) may be implemented by electronic circuitry.

In an embodiment, the database (210) may comprise data that may be either stored or generated as a result of functionalities implemented by any of the components of the processor(s) (202) or the processing engine(s) (208) or the system (200). In an exemplary embodiment, the processing engine(s) (208) may include a patch extraction engine (212), a feature extraction engine (214), a synthetic bright spot generation engine (216), and other engines (218). The other engines (218) may further include, without limitation, an anomaly detection engine, and an image classification engine. Other engine(s) (218) may supplement the functionalities of the processing engine(s) (208) or the system (200). The system (200) may be implemented using any or a combination of hardware components and software components.

In an embodiment, the patch extraction engine (212) may receive EL images (102) of the PV solar panels as an input and removes noise from the EL images (102). The patch extraction engine (212) may extract the PV cell images by splitting the EL images (102) into multiple PV cell images. Each PV cell may include one or more patches with bright spots and one or more patches without bright spots. The patch extraction engine (212) may determine the size of each patch with bright spots and extract the patch with bright spot based on the size of the patch. Further, the patch extraction engine (212) may also extract image embeddings from the PV cell patches based on a CNN.

In an embodiment, the PV cell patches may include a number of pixels. The feature extraction engine (214) may determine pixel intensity and brightness gradient of each pixel of the PV cell patches. Further, the feature extraction engine (214) may extract the features from the PV cell patches based on the pixel intensity and the brightness gradient of each pixel of the PV cell patches.

In an embodiment, the synthetic bright spot generation engine (216) may receive the extracted PV cell images from the patch extraction engine (212), and generate synthetic bright spot images based on the received PV cell images. Further, the synthetic bright spot generation engine (216) may generate synthetic bright spot based on the synthetic bright spot images.

In an embodiment, the anomaly detection engine may receive the extracted image embeddings of the PV cell patches from the patch extraction engine (212), and the extracted features of the PV cell patches from the feature extraction engine (214). Further, the anomaly detection engine may augment the extracted image embeddings of the PV cell patches with the extracted features of the PV cell patches to train an anomaly detection model. The anomaly detection engine may predict probability of bright spots based on the augmented data via the anomaly detection model.

In an embodiment, the image classification engine may receive the synthetic PV cell images containing the bright spot from the synthetic bright spot generation engine (216), and pre-process the synthetic PV cell images containing the bright spot via a Generative Adversarial Network (GAN). The image classification engine may also receive the features of PV cell patches extracted from the feature extraction engine (214). The image classification engine may predict the probability of bright spots based on the pre-processed images and the features of PV cell patches via the CNN.

Although FIG. 2 shows an exemplary block diagram (200) of the bright spot detection system, in other embodiments, the bright spot detection system (200) may include fewer components, different components, differently arranged components, or additional functional components than depicted in FIG. 1. Additionally, or alternatively, one or more components of the bright spot detection system (200) may perform functions described as being performed by one or more other components of the bright spot detection system (200).

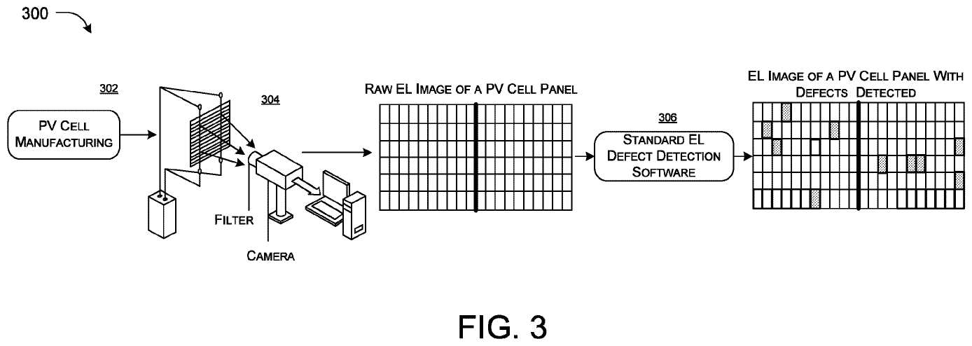

FIG. 3 illustrates an exemplary flow diagram (300) for capturing Electroluminescence (EL) image of a Photo-Voltaic (PV) cell panel, in accordance with an embodiment of the present disclosure. With respect to FIG. 3, at (302), the EL images are captured during a PV solar panel manufacturing process using a specialized equipment (304). The specialized equipment (304) may measure the light emitted by the PV solar panel when a voltage is applied across the PV solar panels. The PV solar panel may include multiple PV cells. The EL images may be used to evaluate the quality of PV cells.

In an embodiment, the specialized equipment (304) may be coupled with a standard EL defect detection software (306) to detect and annotate different kinds of defects (except ‘bright spots’) on the PV cells. These defects may be marked using coloured bounding boxes around the PV cell. The presence of these bounding boxes may act as noise for any method that are used for bright spot detection.

In an embodiment, a noise reduction module may be developed to remove the impact of pre-existing bounding boxes on bright spot detection. The methodology is defined as follows:
a. Identify coloured bounding boxes: In a Red, Green, and Blue (RGB) colour image, each pixel is represented as a combination of three-color channels (Red, Green, and Blue). A pixel in any RGB image may be coloured only when all its channels have different values. The characteristics of coloured pixels may be used to identify coloured bounding boxes.
b. Convert the coloured pixels of bounding boxes to “Black”: To convert the coloured pixels of the bounding boxes to “Black”, the pixel intensity of bounding boxes may be converted to “0”. Since bright spots are areas of high pixel intensity, classification models may be trained to distinguish between the bright spots and the bounding boxes.

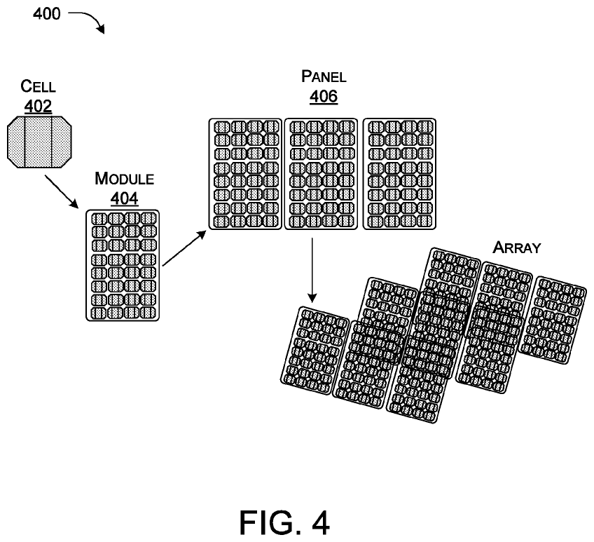

FIG. 4 illustrates an exemplary flow diagram (400) for extracting PV cells from the EL image of the PV solar panel, in accordance with an embodiment of the present disclosure. With respect to FIG. 4, the PV cell (402) may be a basic building block of a PV system. The PV cell (402) may be a small device that converts sunlight directly into electricity. A PV panel (406) may be composed of multiple PV cells connected in series or parallel to add up the voltage and current to match the output power requirements and form an array (408).

In an embodiment, a PV cell extraction may scan the PV panel (406) and extract individual EL images of the PV cells (402). PV cell extraction may involve the following steps:
Identify a number of modules (404) in the PV panel (406) and split the EL image of the PV panel (406) into individual PV module EL images.
Identify a number of PV cells (402) in a PV module EL image and split the EL image of the PV modules (404) into EL images of individual PV cells (402).

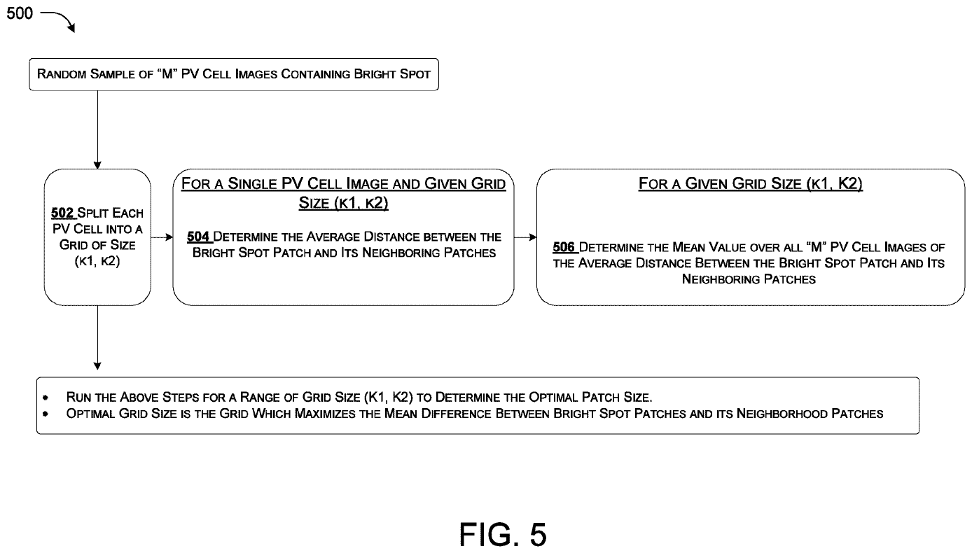

FIG. 5 illustrate an exemplary flow diagram (500) for determining optimal patch size for patch extraction, in accordance with an embodiment of the present disclosure. With respect to FIG. 5, the PV cell EL image may be split into equal sized patches, to enhance the precision of identifying the location of bright spot in a PV panel. The PV cell EL image may be split into patches of any given size. The patch that contains bright spot may differ from the patches without bright spots.

The size of the patch may be an essential hyper parameter that needs to be tuned. The optimal patch size for patch extraction may be identified as follows:
a. Random sample of PV cell images including the bright spot may be received as input, and the PV cell EL image may be split into a grid which maximizes the difference between the patch containing the bright spot and neighbouring patches without bright spots, at 502,
b. For a single PV cell image and given grid size (k1,k2), an average distance between the patch containing the bright spot and the neighbouring patches without bright spots may be determined, at 504, and
c. For the given grid size (k1,k2), a mean value over all the PV cell images of the average distance between the patch containing the bright spot and the neighbouring patches without bright spots may be determined to determine the optimal patch size, at 506.

$$Optimal grid size = ( k {1}^{*} , k {2}^{*} ) = arg max ( D ( k 1 , k 2 ) )$$

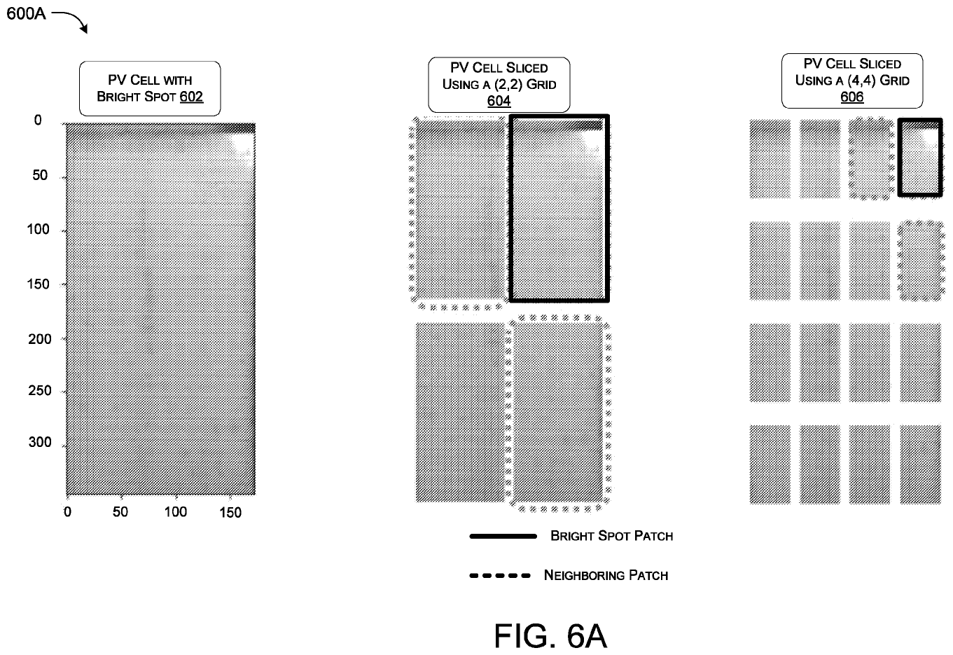

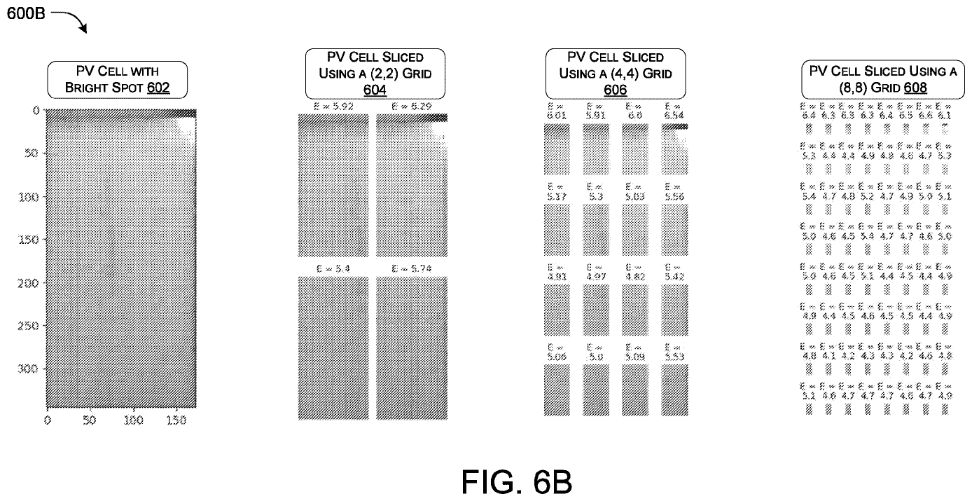

FIGS. 6A and 6B illustrate exemplary representations (600A, 600B) for splitting the PV cell into equal sized optimal patches, in accordance with an embodiment of the present disclosure.

With respect to FIG. 6A, the PV cell image with the bright spot (602), the PV cell sliced using a (2,2) grid (604) and the PV cell sliced using a (4,4) grid (606) are depicted. Several distance metrics may be available to measure the difference between any two patches. Below is an indicative (Non-Exhaustive) list of metrics that can be used.
Jensen-Shannon (JS) divergence,
Difference in entropy of the two patches, and
Difference in variance of the two patches.

With respect to FIG. 6B, the PV cell sliced using a (8,8) grid (608) is shown and an example using difference in entropy as a distance metric may be depicted.
A high entropy value may indicate that the EL image has a large degree of variation in pixel intensities and contains a lot of information.
Shannon's entropy may be determined by analysing the distribution of the pixel intensities. The entropy may be calculated as:

$$H ( X ) = - {\sum }_{x ∈ X} p ( x ) log ( x ) = 𝔼 [ - log p ( X ) ] \qquad ( eq . 1 )$$

p(x) is the probability of a particular pixel intensity value x occurring in the EL image
The PV cell EL image may be split into the grid which maximizes the difference in entropy between the patch containing the bright spot and the neighbouring patches without the bright spots. In other words, the grid size that maximizes entropy difference may be chosen.

$$Entropy Difference = Entropy ( Patch with Bright Spot ) - Average Entropy of Neighboring Patch \qquad ( eq . 2 )$$

Once the optimal grid size is decided, the PV cell EL images may be split into optimal patches of pixel dimensions P×Q.

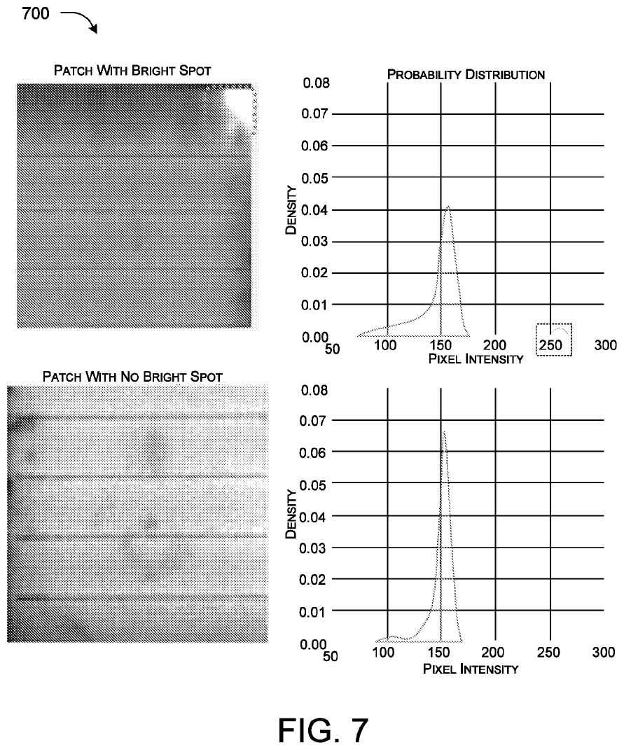

FIG. 7 illustrates an exemplary view (700) representing a probability distribution of a patch with bright spot and a probability distribution of a patch with no bright spot, in accordance with an embodiment of the present disclosure. With respect to FIG. 7, each extracted patch may be a matrix of P×Q pixels. The value of each of the pixels may describe how bright/dark that pixel is. Smaller numbers that are closer to zero may represent black i.e., patches without bright spots, and the larger numbers which are closer to 255 may denote white i.e., patches with bright spots. The probability distribution of pixels may show that the bright spots are denoted as outliers with a pixel intensity closer to 255.

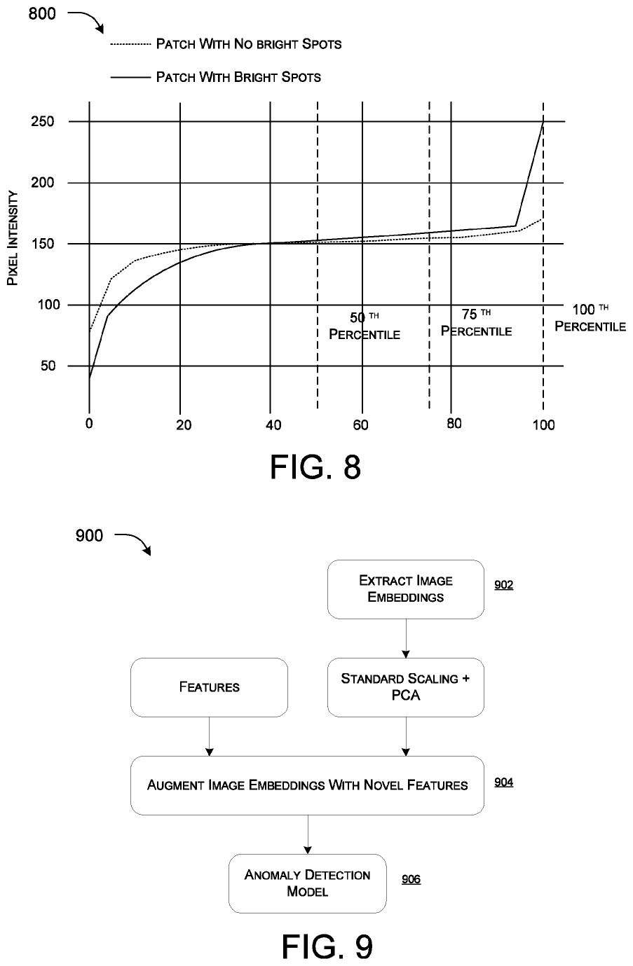

FIG. 8 illustrates an exemplary graphical view (800) representing a comparison between the patch with bright spot and the patch with no bright spot, in accordance with an embodiment of the present disclosure. With respect to FIG. 8, an Inverse Cumulative Density Function (ICDF) plot may represent the pixel intensities at each percentile level. The ICDF plot may be from an EL image patch with the bright spot. The presence of a steep slope after the 95^{th} percentile may indicate the presence of bright spot in this example. However, for any bright spot containing patch in general, the steep slope may be observed after some p-th percentile, where p∈[0, 1]. This observation may be used to generate features that may be used as key in discriminating the bright spot patches from the non-bright spot patches. Based on the above analysis, following features may be extracted from the PV cell patches based on the pixel intensities and a gradient of ICDF as shown in Table 1:

TABLE 1

| Feature Name | Feature Description |
|---|---|
| Maximum intensity | Maximum Pixel Intensity |
| High Intensity Flag | 1 if maximum pixel intensity >= |
| | 0.95, 0 otherwise |
| Slope of ICDF between maximum and p-th percentile pixel intensities | $\frac{I C D F ( 1 ) - I C D F ( p )}{1 - p} , p ∈ [ 0 , 1 ]$ |
| Ratio of maximum and p-th percentile ICDF | $\frac{I C D F ( 1 )}{I C D F ( p )} , p ∈ [ 0 , 1 ]$ |

By extracting the above features from the PV cell patches, a high-dimensional feature space that captures the most discriminative characteristics of the bright spots may be created. Using these features as inputs to a classification/anomaly detection model, the bright spots may be detected efficiently and reliably in any RGB PV cell/panel EL image.

FIG. 9 illustrates an exemplary flow diagram (900) for training an anomaly detection module, in accordance with an embodiment of the present disclosure. With respect to FIG. 9, anomaly detection methods may be unsupervised machine learning models aimed to identify rare or unusual patterns in data. The methodology may be summarized as follows:

Feature Extraction: A deep CNN model trained on a large image dataset (e.g., ImageNet) may be used to extract (902) image embeddings. A major advantage of using pre-trained models may be the ability to identify complex patterns and extract high-quality features without the need for feature engineering. Further, the image embeddings may be augmented (904) with the features extracted in the previous step as shown in FIG. 8.

Model Training: An anomaly detection model (e.g., Isolation Forests) may be trained (906) only on the PV cell patches with no bright spots based on the augmented data.

Bright Spot Detection: The trained anomaly detection model may be used to detect the bright spots. If the trained anomaly detection model detects a pattern that is significantly different from the norm (No Bright Spots), the trained anomaly detection model may flag it as an anomaly (Bright Spots).

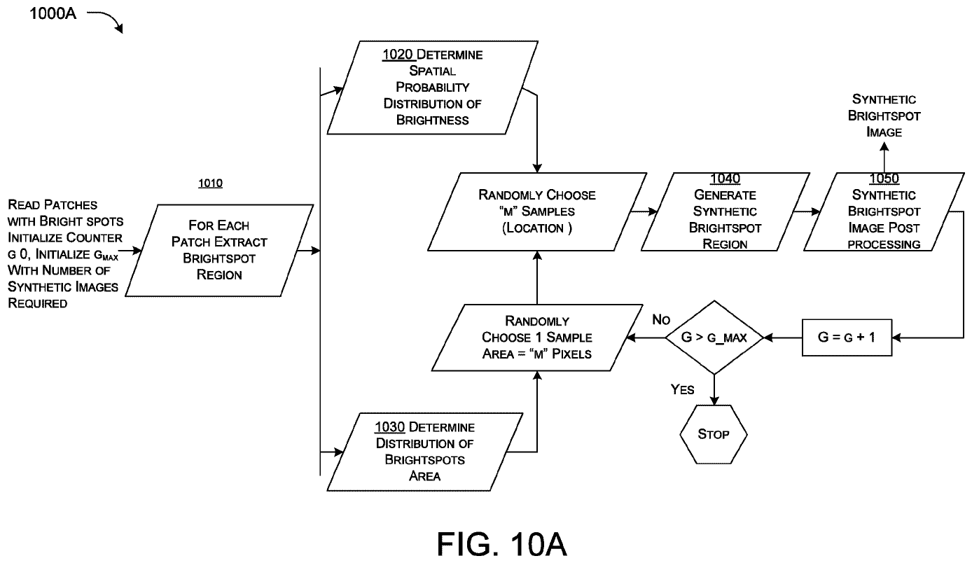

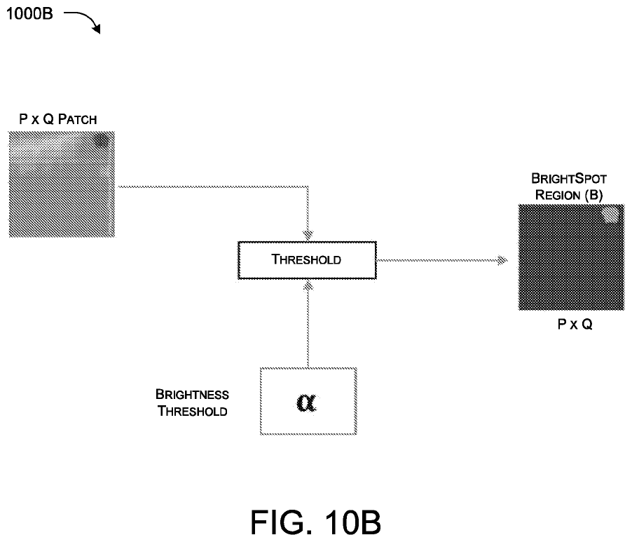

FIGS. 10A and 10B illustrate exemplary flow diagram (1000A, 1000B) for generating synthetic bright spots, in accordance with an embodiment of the present disclosure. With respect to FIG. 10A, for each real bright spot patch, a counter g=0, and gₘₐₓ with number of synthetic images required may be initialized.

At 1010, for each real bright spot patch, a bright spot region (B) may be extracted by following steps:
a. Create an array of zeroes with dimensions matching the patch size (P×Q).
b. If the pixel intensity of any element in the patch is higher than the input brightness threshold (α), the corresponding elements may be set in the array to 1.

$${B}_{( x , y )}^{i} = \{ 1 if {I}_{( x , y )}^{i} > α ; 0 otherwise \} for 1 \leq x \leq P , 1 \leq y \leq Q$$

∀i∈[1, n] where n is number of patches with bright spot

$${I}_{( x , y )}^{i} - Pixel Intensity at ( x , y ) coordinate of {i}^{th} bright spot patch$$

The value of a for threshold to extract the bright spot region (B) is depicted in FIG. 10B.

At 1020, spatial probability distribution of the bright spots may be determined in response to extraction of the bright spot region (B).

At 1030, probability distribution of the bright spot region (B) may be determined by detecting a number of elements in the bright spot region (B).

At 1040, a synthetic bright spot region may be generated by randomly choosing the bright spots and randomly choosing the locations of the bright spots, based on the spatial probability distribution of the bright spots and the probability distribution of the bright spot region (B).

At 1050, one or more synthetic bright spots may be generated by receiving synthetic bright spot image and pre-processing the synthetic bright spot region.

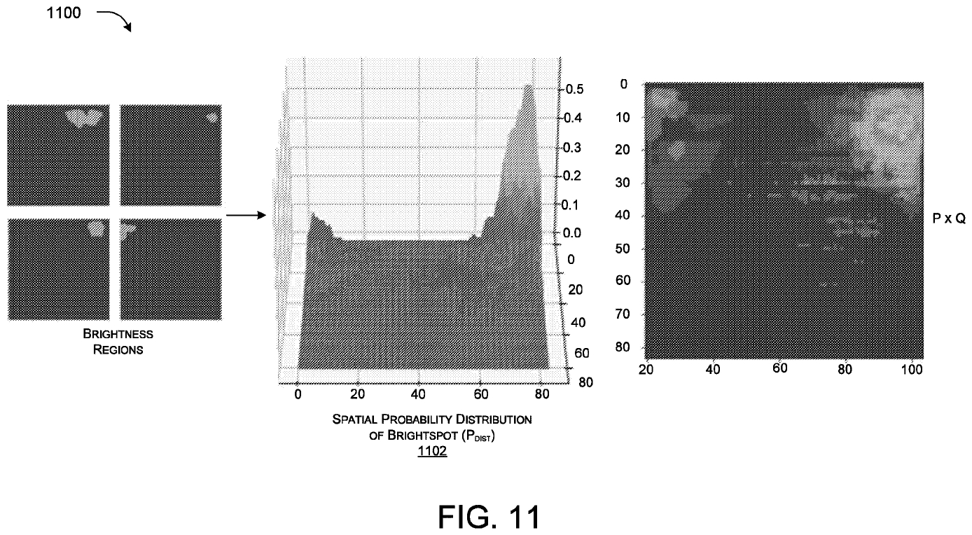

FIG. 11 illustrates exemplary views (1100) representing spatial probability distribution of the bright spots, in accordance with an embodiment of the present disclosure. With respect to FIG. 11, the spatial probability distribution (1120) of the bright spots may be determined from brightness regions (1110) using the following eq. 3, given that there are n patches of bright spots with P×Q dimension.

$${P}_{dist} = f ( x , y ) = \frac{\frac{1}{n} {\sum }_{i = 1}^{n} {B}_{( x , y )}^{i}}{{\sum }_{x}^{P} {\sum }_{y}^{Q} ( \frac{1}{n} {\sum }_{i = 1}^{n} {B}_{( x , y )}^{i} )} , \qquad ( eq . 3 )$$

where n is number of patches with bright spot.

$$∀ x ∈ [ 1 , P ]$$

$$∀ y ∈ [ 1 , Q ]$$

The spatial probability distribution of bright spot may have the same dimension as the patches (i.e., P×Q).

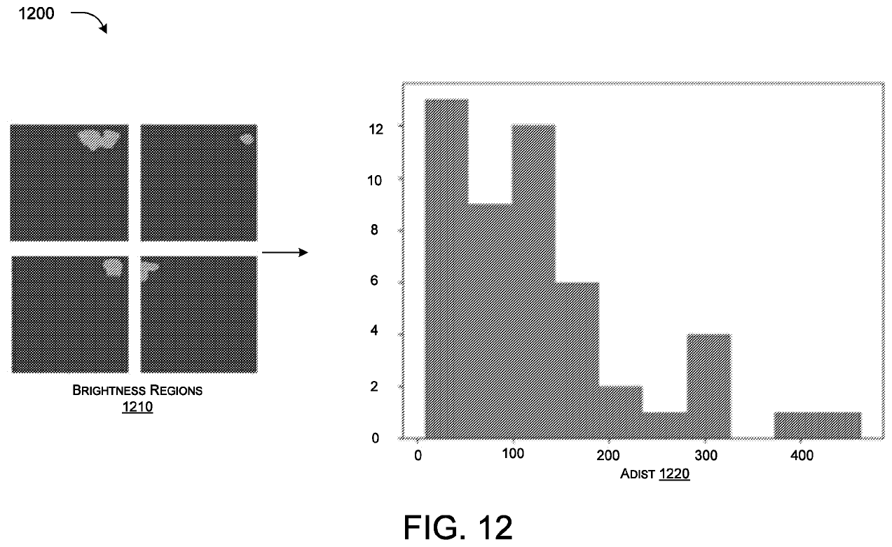

FIG. 12 illustrates exemplary views (1200) representing probability distribution of the bright spot region, in accordance with an embodiment of the present disclosure. With respect to FIG. 12, to determine the bright spot region (1210) within a patch, the number of elements in the bright spot region (B) that have a value of 1 may be counted. Utilizing this information from all n patches with the bright spot, the distribution of the bright spot areas (A_{dist}) (1220) may be created and determined as follows:

$${A}_{dist} ∼ N ( i ) where N ( i ) = {\sum }_{x}^{P} {\sum }_{y}^{Q} {B}_{( x , y )}^{i} and i ∈ [ 1 , n ] ⋂ Z \qquad ( eq . 4 )$$

where n is number of patches with bright spot.

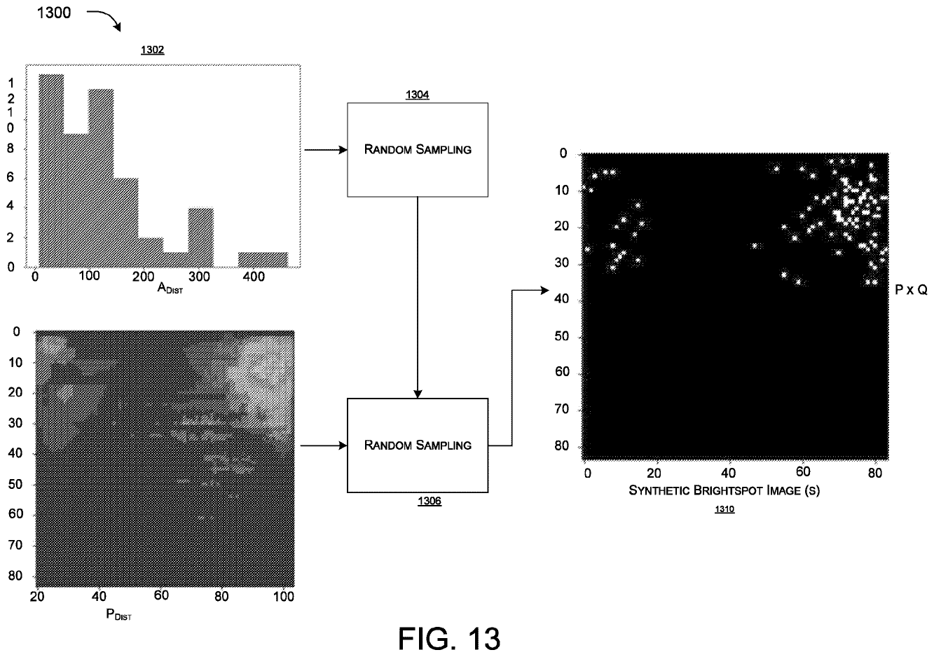

FIG. 13 illustrates an exemplary flow diagram (1300) for generating synthetic bright spot image, in accordance with an embodiment of the present disclosure. With respect to FIG. 13, synthetic bright spot image (1340) may be generated by:
a. Creating an array(S) of zeroes with dimensions matching the patch size (P×Q) (1310).
b. Randomly sampling (1320) the value for bright spot area, “a” from A_{dist}.
c. Randomly sampling “a” number of (x, y) coordinates from the probability distribution P_{dist} (1330).
d. For all the selected coordinates, setting S_((x,y)) as 255, to generate the synthetic bright spot image (1340).

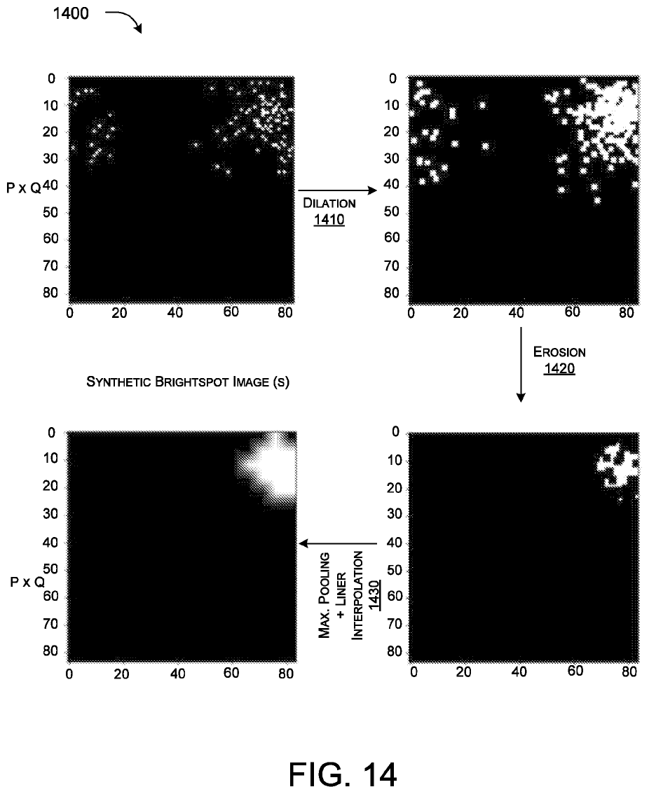

FIG. 14 illustrates an exemplary flow diagram (1400) representing pre-processing of the synthetic bright spot image, in accordance with an embodiment of the present disclosure. With respect to FIG. 14, dilation (1410) followed by erosion (1420) may be performed on the synthetic bright spot image. By performing dilation (1410) followed by erosion (1420) on the synthetic bright spot image, a refined irregular shape for a synthetic bright spot may be created. Further, max pooling on the eroded image followed by linear interpolation (1430) may be performed to bring the image back to its original dimensions of P×Q.

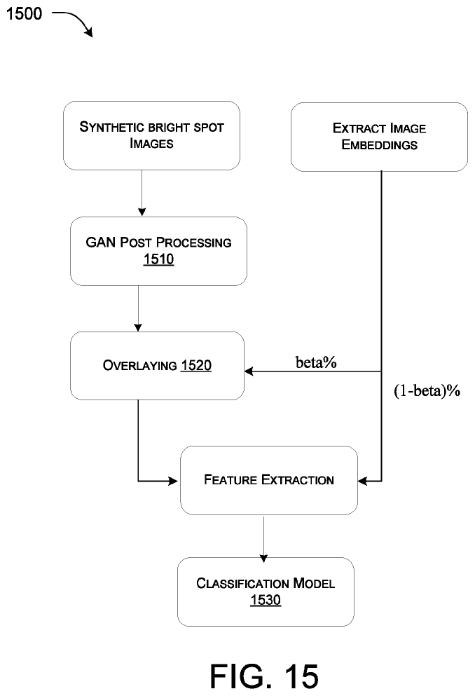

FIG. 15 illustrates an exemplary flow diagram (1500) for training a classification model, in accordance with an embodiment of the present disclosure. With respect to FIG. 15, synthetic bright spot images (1510) and non-bright spot patches 1540) may be processed using an image classification methodology summarized as follows:

Generative Adversarial Network (GAN) Post Processing (1520): A GAN may be trained with the synthetic bright spot samples. The main goal of training the GAN is to enable a generator to produce new yet realistic bright spot images when fed with synthetic bright spot samples.

Overlaying (1530): The synthetic bright spot images may be essentially bright pixels on a black/dark background. The synthetic bright spot images may be overlaid on top of non-bright spot patches to emulate bright spots. Overlaying/blending may be achieved through weighted addition of two image arrays. Brightness of the synthetic bright spot images may be adjusted pre or post blending to handle the reduction in brightness caused by black/dark background in synthetic bright spot images.

Classification model training (1560): A classification model(s) may be trained on the features extracted (1550) from the synthetic bright spot images (1510), and the non-bright spot patches (1540).

Bright Spot Detection: The trained classification model (1560) may be used to predict the probability of having bright spots in the PV solar panels.

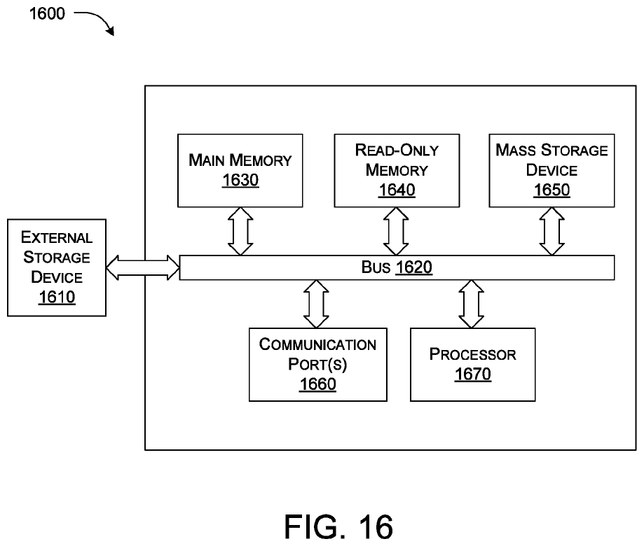

FIG. 16 illustrates an exemplary computer system (1600) in which or with which embodiments of the present disclosure may be implemented.

As shown in FIG. 16, the computer system (1600) may include an external storage device (1610), a bus (1620), a main memory (1630), a read only memory (1640), a mass storage device (1650), a communication port (1660), and a processor (1670).

A person skilled in the art will appreciate that the computer system (1600) may include more than one processor and communication ports. The processor (1670) may include various modules associated with embodiments of the present disclosure.

In an embodiment, the communication port (1660) may be any of an RS-232 port for use with a modem-based dialup connection, a 10/100 Ethernet port, a Gigabit or 10 Gigabit port using copper or fiber, a serial port, a parallel port, or other existing or future ports. The communication port (1660) may be chosen depending on a network, such a Local Area Network (LAN), Wide Area Network (WAN), or any network to which the computer system (1600) connects.

In an embodiment, the memory (1630) may be a Random Access Memory (RAM), or any other dynamic storage device commonly known in the art. The read-only memory (1640) may be any static storage device(s) e.g., but not limited to, a Programmable Read Only Memory (PROM) chips for storing static information e.g., start-up or Basic Input/Output system (BIOS) instructions for the processor (1670).

In an embodiment, the mass storage (1650) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks (e.g., SATA arrays).

In an embodiment, the bus (1620) communicatively couples the processor(s) (1670) with the other memory, storage, and communication blocks. The bus (1620) may be, e.g., a Peripheral Component Interconnect (PCI)/PCI Extended (PCI-X) bus, Small Computer System Interface (SCSI), Universal Serial Bus (USB or the like, for connecting expansion cards, drives, and other subsystems as well as other buses, such a front side bus (FSB), which connects the processor (1670) to computer system (1600).

Optionally, operator and administrative interfaces, e.g., a display, keyboard, joystick, and a cursor control device, may also be coupled to the bus (1620) to support direct operator interaction with the computer system (1600). Other operator and administrative interfaces may be provided through network connections connected through the communication port (1660). Components described above are meant only to exemplify various possibilities. In no way should the aforementioned exemplary computer system (1600) limit the scope of the present disclosure.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

The present disclosure performs precise and reliable detection of bright spot defects in PV solar panels.

The present disclosure addresses the issue of class imbalance resulting from the infrequency of bright spots.

The present disclosure incorporates statistically-derived features of bright spot to enhance the system's reliability.

The present disclosure incorporates a synthetic data generation system to enhance the system's reliability.

The present disclosure includes a multi-model voting-based approach with a mix of unsupervised (anomaly detection) and supervised (classification) methods to increase system robustness.

We claim:

1. A system (200) for detecting bright spots in a Photo-Voltaic (PV) solar panel, the system (200) comprising:
one or more processors (202); and
a memory (204) operatively coupled to the one or more processors (202), wherein the memory (204) comprises processor-executable instructions, which on execution, cause the one or more processors (202) to:
receive an electroluminescence (EL) image of a PV solar panel;
extract one or more optimal patches from the received EL image of the PV solar panel;
extract one or more features from the extracted one or more optimal patches;
generate one or more synthetic bright spots to train a classification model based on the extracted one or more features; and
detect, via the classification model, bright spots in the PV solar panel.

2. The system (200) as claimed in claim 1, wherein the received EL image of the PV solar panel comprises the one or more optimal patches with the bright spots and one or more patches with no bright spots marked using one or more coloured bounding boxes.

3. The system (200) as claimed in claim 1, wherein the one or more processors (202) are to extract the one or more optimal patches from the received EL image of the PV solar panel by being configured to:
detect one or more coloured pixels from the received EL image of the PV solar panel;
identify one or more coloured bounding boxes based on the one or more coloured pixels;
convert pixel intensity of the one or more coloured bounding boxes to 0 to remove noise from the received EL image of the PV solar panel; and
extract the one or more optimal patches from the received EL image of the PV solar panel based on the pixel intensity.

4. The system (200) as claimed in claim 1, wherein the memory (204) comprises processor-executable instructions, which on execution, cause the one or more processors (202) to extract one or more PV cells from the PV solar panel.

5. The system (200) as claimed in claim 4, wherein the one or more processors (202) are to extract the one or more PV cells from the PV solar panel by being configured to:
identify a number of modules in the PV solar panel;
split the EL image of the PV solar panel into one or more PV module EL images based on the number of modules in the PV solar panel;
identify a number of cells in at least one PV module EL image of the one or more PV module EL images;
split the at least one PV module EL image into one or more PV cells EL images; and
extract the one or more PV cells based on the one or more PV cells EL images.

6. The system (200) as claimed in claim 5, wherein the memory (204) comprises processor-executable instructions, which on execution, cause the one or more processors (202) to split the one or more PV cells EL images into equal sized patches and identify an exact location of at least one bright spot in the PV solar panel.

7. The system (200) as claimed in claim 1, wherein the memory (204) comprises processor-executable instructions, which on execution, cause the one or more processors (202) to identify a size of the one or more optimal patches, and wherein the one or more optimal patches are one or more patches with the bright spots.

8. The system (200) as claimed in claim 7, wherein the one or more processors (202) are to identify the size of the one or more optimal patches by being configured to:
split one or more PV cell EL images into at least one grid which maximizes a difference between the one or more patches with the bright spots and one or more patches with no bright spots;
determine an average distance between the one or more patches with the bright spots and the one or more patches with no bright spots;
determine a mean value of the average distance between the one or more patches with the bright spots and the one or more patches with no bright spots over all the one or more PV cell EL images; and
identify the size of the one or more patches with the bright spots based on the mean value.

9. The system (200) as claimed in claim 1, wherein the one or more processors (202) are to extract the one or more features from the extracted one or more optimal patches by being configured to:
determine whether pixel intensity of each pixel of one or more patches is greater than a pre-configured value using an Inverse Cumulative Density Function (ICDF);
detect one or more patches comprising a bright spot as the one or more optimal patches in response to a determination that the pixel intensity of each pixel of the one or more patches is greater than the pre-configured value;
extract the one or more optimal patches based on the detection; and
extract the one or more features from the extracted one or more optimal patches based on the pixel intensity of each pixel of the extracted one or more optimal patches and a gradient of the ICDF.

10. The system (200) as claimed in claim 9, wherein the one or more features comprise at least one of: a value of maximum pixel intensity, a flag representing high pixel intensity, a slope of ICDF between any intervals of pixel intensity percentiles, and a ratio of ICDF between any intervals of pixel intensity percentiles.

11. The system (200) as claimed in claim 1, wherein the one or more processors (202) are to generate the one or more synthetic bright spots by being configured to:
extract at least one bright spot region for each patch comprising the bright spots;
determine a spatial probability distribution of the bright spots;
determine a probability distribution of the at least one bright spot region by detecting a number of elements in the at least one bright spot region;
generate at least one synthetic bright spot region based on the spatial probability distribution of the bright spots and the probability distribution of the at least one bright spot region; and
generate the one or more synthetic bright spots by capturing and pre-processing the at least one synthetic bright spot region.

12. The system (200) as claimed in claim 1, wherein the memory (204) comprises processor-executable instructions, which on execution, cause the one or more processors (202) to:
receive the extracted one or more optimal patches as input;
extract image embeddings from the received EL image of the PV solar panel via a pre-trained Convolutional Neural Network (CNN) model;
augment the extracted one or more features with the extracted image embeddings and
train an anomaly detection model to detect the bright spots.

13. The system (200) as claimed in claim 12, wherein the anomaly detection model is trained on one or more patches with no bright spots.

14. The system (200) as claimed in claim 1, wherein the one or more processors (202) are to detect the bright spots in the PV solar panel by being configured to:
generate realistic bright spot images for the one or more synthetic bright spots by training a Generative Adversarial Network (GAN) with the one or more synthetic bright spots;
blend the realistic bright spot images on top of one or more patches with no bright spot to emulate the bright spots;
extract one or more features from one or more patches with the bright spots and one or more features from the one or more patches with no bright spots in response to blending the realistic bright spot images; and
train the classification model based on the extracted one or more features of the one or more patches with bright spots and the extracted one or more features of the one or more patches with no bright spots.

15. A method for detecting bright spots in a Photo-Voltaic (PV) solar panel, the method comprising:
receiving, by a processor (202) associated with a system (200), an electroluminescence (EL) image of a PV solar panel;
extracting, by the processor (202), one or more optimal patches from the received EL image of the PV solar panel;
extracting, by the processor (202), one or more features from the extracted one or more optimal patches;
generating, by the processor (202), one or more synthetic bright spots to train a classification model based on the extracted one or more features; and
detecting, by the processor (202), bright spots in the PV solar panel via the classification model.

16. The method as claimed in claim 15, wherein the received EL image of the PV solar panel comprises one or more optimal patches with bright spots and one or more patches with no bright spots marked using one or more coloured bounding boxes.

17. The method as claimed in claim 15, wherein extracting, by the processor (202), the one or more optimal patches from the received EL image of the PV solar panel comprises:
detecting, by the processor (202), one or more coloured pixels from the received EL image of the PV solar panel;
identifying, by the processor (202), one or more coloured bounding boxes based on the one or more coloured pixels;
converting, by the processor (202), pixel intensity of the one or more coloured bounding boxes to 0 to remove noise from the received EL image of the PV solar panel; and
extracting, by the processor (202), the one or more optimal patches from the received EL image of the PV solar panel based on the pixel intensity.

18. The method as claimed in claim 15, comprising extracting, by the processor (202), one or more PV cells from the PV solar panel.

19. The method as claimed in claim 18, wherein extracting, by the processor (202), the one or more PV cells from the PV solar panel comprises:
identifying, by the processor (202), a number of modules in the PV solar panel;
splitting, by the processor (202), the EL image of the PV solar panel into one or more PV module EL images based on the number of modules in the PV solar panel;
identifying, by the processor (202), a number of cells in at least one PV module EL image of the one or more PV module EL images;
splitting, by the processor (202), the at least one PV module EL image into one or more PV cells EL images; and
extracting, by the processor (202), the one or more PV cells based on the one or more PV cells EL images.

20. The method as claimed in claim 19, comprising:
splitting, by the processor (202), the one or more PV cells EL images into equal sized patches; and
identifying, by the processor (202), exact location of at least one bright spot in the PV solar panel.

21. The method as claimed in claim 15, comprising:
identifying, by the processor (202), a size of the one or more optimal patches, wherein the one or more optimal patches are one or more patches comprising the bright spots.

22. The method as claimed in claim 21, wherein identifying, by the processor (202), the size of the one or more optimal patches comprises:
splitting, by the processor (202), one or more PV cell EL images into at least one grid which maximizes a difference between the one or more patches with the bright spots and one or more patches with no bright spots;
determining, by the processor (202), an average distance between the one or more patches with the bright spots and the one or more patches with no bright spots;
determining, by the processor (202), a mean value of the average distance between the one or more patches with the bright spots and the one or more patches with no bright spots over all the one or more PV cell EL images; and
identifying, by the processor (202), the size of the one or more patches with the bright spots based on the mean value.

23. The method as claimed in claim 15, wherein extracting, by the processor (202), the one or more features from the extracted one or more optimal patches comprises:
determining, by the processor (202), whether pixel intensity of each pixel of one or more patches is greater than a pre-configured value via an Inverse Cumulative Density Function (ICDF);
detecting, by the processor (202), one or more patches comprising a bright spot as the one or more optimal patches in response to a determination that the pixel intensity of each pixel of the one or more patches is greater than the pre-configured value;
extracting, by the processor (202), the one or more optimal patches based on the detection; and
extracting, by the processor (202), the one or more features from the extracted one or more optimal patches based on the pixel intensity of each pixel of the extracted one or more optimal patches and a gradient of the ICDF.

24. The method as claimed in claim 23, wherein the one or more features comprise at least one of: a value of maximum pixel intensity, a flag representing high pixel intensity, a slope of ICDF between any intervals of pixel intensity percentiles, and a ratio of ICDF between any intervals of pixel intensity percentiles.

25. The method as claimed in claim 15, wherein generating, by the processor (202), the one or more synthetic bright spots comprises:
extracting, by the processor (202), at least one bright spot region for each patch comprising the bright spots;
determining, by the processor (202), a spatial probability distribution of the bright spots;
determining, by the processor (202), a probability distribution of the at least one bright spot region by detecting a number of elements in the at least one bright spot region;
generating, by the processor (202), at least one synthetic bright spot region based on the spatial probability distribution of the bright spots and the probability distribution of the at least one bright spot region; and
generating, by the processor (202), the one or more synthetic bright spots by pre-processing the at least one synthetic bright spot region.

26. The method as claimed in claim 15, comprising:
receiving, by the processor (202), the extracted one or more optimal patches as an input;
extracting, by the processor (202), image embeddings from the received EL image of the PV solar panel via a pre-trained Convolutional Neural Network (CNN) model;
augmenting, by the processor (202), the extracted one or more features with the extracted image embeddings; and
training, by the processor (202), an anomaly detection model to detect the bright spots.

27. The method as claimed in claim 26, wherein the anomaly detection model is trained on one or more patches with no bright spots.

28. The method as claimed in claim 15, wherein detecting, by the processor (202), the bright spots in the PV solar panel comprises:
generating, by the processor (202), realistic bright spot images for the one or more synthetic bright spots by training a Generative Adversarial Network (GAN) with the one or more synthetic bright spots;
blending, by the processor (202), the realistic bright spot images on top of one or more patches with no bright spots to emulate the bright spots;
extracting, by the processor (202), one or more features from one or more patches with the bright spots and one or more features from one or more patches with no bright spots in response to blending the realistic bright spot images; and
training, by the processor (202), the classification model based on the extracted one or more features of the one or more patches with the bright spots and the extracted features of the one or more patches with no bright spots.

29. A user equipment, comprising:
one or more processors; and
a memory operatively coupled to the one or more processors, wherein the memory comprises processor-executable instructions, which on execution, cause the one or more processors to:
capture an electroluminescence (EL) image of a Photo-Voltaic (PV) solar panel; and
send the EL image of the PV solar panel to a system (200);
wherein the one or more processors are communicatively coupled with the system (200), and wherein the system (200) is configured to:
receive the EL image of the PV solar panel;
extract one or more optimal patches from the received EL image of the PV solar panel;
extract one or more features from the extracted one or more optimal patches;
generate one or more synthetic bright spots to train a classification model based on the extracted one or more features; and
detect bright spots in the PV solar panel via the classification model.

30. A non-transitory computer-readable medium comprising processor-executable instructions that cause a processor to:
receive an electroluminescence (EL) image of a Photo-Voltaic (PV) solar panel;
extract one or more optimal patches from the received EL image of the PV solar panel;
extract one or more features from the extracted one or more optimal patches;
generate one or more synthetic bright spots to train a classification model based on the extracted one or more features; and
detect, via the classification model, bright spots in the PV solar panel.
